(19) United States
(12) Patent Application Publication
(10) Pub. No.: US 2024/0353547 A1
(43) Pub. Date: Oct. 24, 2024

(54) DEVICE AND METHOD FOR DETECTING AND LOCATING UNDERWATER OBJECTS

(71) Applicant: EXAIL ROBOTICS, LA GARDE (FR)

(72) Inventors: Marc PINTO, LA GARDE (FR); David DRAY, LA GARDE (FR); Stéphane MELTZHEIM, LA GARDE (FR)

(21) Appl. No.: 18/685,951

(22) PCT Filed: Aug. 31, 2022
(86) PCT No.: PCT/FR2022/051633

§ 371 Date: Feb. 23, 2024

(30) Foreign Application Priority Data
Sep. 2, 2021 (FR) 2109189

(51) Int. Cl. G01S 7/527; B63G 7/00; G01S 7/539; G01S 15/42; G01S 15/46; G01S 15/89

(52) U.S. Cl. CPC G01S 7/527; B63G 7/00; G01S 7/539; G01S 15/42; G01S 15/8904; B63G 2007/005; G01S 2015/465

(57) ABSTRACT

An underwater vehicle provided with a sonar for detecting underwater objects, the sonar being a sonar whose angular coverage in elevation is comprised between 45 and 240 degrees, is oriented towards the surface when the underwater vehicle is in the detection phase of an underwater object and whose angular coverage in bearing is less than 10 degrees to obtain measurements in a plane, all the measurements of a plane being obtained in one emission/reception cycle, the sonar allowing the detection of underwater objects located at a depth less than that of the underwater vehicle.

### CROSS-REFERENCE TO RELATED APPLICATIONS

This application is a National Stage of International Application No. PCT/FR2022/051633, having an International Filing Date of 31 Aug. 2022, which designated the United States of America, and which International Application was published under PCT Article 21 (2) as WO Publication No. 2023/031553 A1, which claims priority from and the benefit of French Patent Application No. 2109189 filed on 2 Sep. 2021, the disclosures of which are incorporated herein by reference in their entireties.

### BACKGROUND

### Field

The present disclosure relates to the field of detection and localisation, using one or more sonars, of objects submerged or buoyant between two waters such as tethered mines and drifting mines.

### Brief Description of Related Developments

A tethered mine is a mine with positive buoyancy, submerged or buoyant between two waters. It is connected by a cable, called a rope, to a dead body resting on a seabed, called a toad. It is triggered automatically when a surface ship or submarine comes into contact with it or passes near it. Often used intensively, they represent a serious threat to maritime forces and maritime commercial traffic. There is therefore a real need to detect, locate and destroy them.

Apart from the sonars (acronym for sound navigation and ranging) used by mine hunters, the vast majority of existing sonars for detecting tethered and drift mines are frontal sonars called frontal avoidance sonars (also called Mine and Obstacle Avoidance Sonar or MOAS), installed under the hull of surface ships which are high-value platforms (also called High Value Unit or HVU). The sonar then has the essential mission of self-protection of the HVU and, for these purposes, must detect mines at low immersion at a great range in front of the ship, in order to give the latter time to carry out an avoidance manoeuvre, including when it is launched at full speed, for example during a transit.

The detection geometry, very horizontal due to the low immersion of the sonar and the mines, is a challenge, particularly in rough seas. Indeed, this geometry is very unfavourable for the propagation of sound, the almost horizontal orientation of the rays leading to considerable absorption losses, due in particular to bubbles in rough seas, which can lead to extinction of the emitted signal.

These constraints lead to complicated and expensive sonars, which is not desirable for mine-hunting drone sonars. Indeed, these drones are intended to spend a substantial amount of time in minefields to detect and neutralise mines and not just avoid them like an HVU. The needs are therefore different. For a drone, the self-protection function, although essential, remains secondary to the main mission of detecting mines on the seabed but also throughout the water column (the sonars allowing to carry out such detections are generally called Volume Search Sonar in or VSS).

By way of illustration, patent application US 2020/0333787 describes the implementation of an electronic scan MOAS on a surface drone. The solution is identical to that proposed for HVUs, with the disadvantages described above.

Patent U.S. Pat. No. 5,506,812 describes a VSS with lateral vision, called TVSS (acronym for Toroidal Volume Search Sonar). It uses a cylindrical emission and reception antenna mounted on a towed fish, which insonifies in a single ping (that is to say a single emission/reception cycle) a toroidal zone of 3 degrees in bearing (called along-track) and 360 degrees in elevation (called across-track), sweeping a large cylindrical volume around the path of the fish as it advances. This geometry is effective for detection due to the exclusion of reverberations from the surface or seabed interfaces of most range gates of the water column where mines are sought. Even very low index targets can then be detected. However, TVSS is complicated and therefore expensive.

The present disclosure aims at overcoming the disadvantages of the prior art by providing a system offering high resolution in bearing and allowing the detection of mines close to the surface.

### SUMMARY

To overcome at least one of the problems mentioned above, provision is thus made of an underwater vehicle provided with at least one sonar for the detection of underwater objects, the at least one sonar being a sonar whose angular coverage in elevation is comprised between 45 and 240 degrees, is oriented towards the surface when the underwater vehicle is in the detection phase of an underwater object and whose angular coverage in bearing is less than 10 degrees to obtain measurements in a plane, all the measurements of a plane being obtained in one emission/reception cycle, the at least one sonar allowing the detection of underwater objects located at a depth less than that of the underwater vehicle. The at least one sonar is for example a scanning sonar whose scanning is carried out by the movement of the underwater vehicle.

Such a solution is more efficient than the solutions known from the prior art as presented above and costs less to implement.

According to particular aspects, the at least one sonar is provided with a longitudinal emission antenna oriented along the axis of the underwater vehicle, allowing broadband emission.

Still according to particular aspects, the at least one sonar is provided with a linear or curved transverse reception antenna.

Still according to particular aspects, the cover is oriented forward in a longitudinal vertical plane of the underwater vehicle, at an angle comprised between 5 and 25 degrees when the underwater vehicle is in the detection phase of an underwater object. The at least one sonar may in particular be with a scanning in a longitudinal vertical plane of the underwater vehicle, said scanning in a longitudinal vertical plane of the underwater vehicle being controlled independently of the advance of the underwater vehicle.

Still according to particular aspects, the at least one sonar is a multibeam sonar.

Still according to particular aspects, the at least one sonar is a side sonar. It may in particular be a synthetic antenna sonar. It can be coloured emission sonar.

Still according to particular aspects, the at least one sonar is made up of a plurality of sonars.

Still according to particular aspects, the vehicle further comprises a second sonar configured to detect underwater objects located at a depth greater than that of the underwater vehicle. The second sonar may in particular be a synthetic antenna sonar.

Still according to particular aspects, the vehicle further comprises correlation means for correlating data from said at least sonar and said second sonar, an underwater object being identified and located according to a correlation result.

Still according to particular aspects, the vehicle is autonomous.

The disclosure also relates to a method for detecting an underwater object, in an underwater vehicle provided with at least one sonar, the method comprising the emission of an acoustic signal towards the surface according to an angular coverage in elevation comprised between 45 and 240 degrees and an angular coverage in bearing less than 10 degrees, the acquisition of acoustic signals in return of the signal emitted to obtain measurements in a plane, all the measurements of a plane being obtained in one emission/reception cycle and the processing of the acquired signals to detect and locate an underwater object located at a depth less than that of the underwater vehicle. Such a method allows effective detection of underwater objects, in particular underwater objects located close to the surface.

According to particular aspects, the acoustic signal is emitted forward in a longitudinal vertical plane of the underwater vehicle, at an angle comprised between 5 and 25 degrees.

Still according to particular aspects, the method further comprises the emission of an acoustic signal towards the seabed, the acquisition of acoustic signals in return of the signal emitted towards the seabed and the correlation of data obtained by processing the acquired signals in return for the signals emitted towards the surface and towards the seabed.

### BRIEF DESCRIPTION OF THE FIGURES

Other features, details and advantages of the disclosure will appear upon reading the detailed description below. This is purely illustrative and must be read in conjunction with the appended drawings, wherein:

FIG. 1 illustrates an example of an underwater vehicle, seen from the side, provided with several sonars, according to aspects of the disclosure;

FIG. 2 illustrates the underwater vehicle shown in FIG. 1, seen from the front;

FIG. 3 schematically illustrates a second example of configuration of an underwater vehicle, seen from the front, according to aspects of the disclosure;

FIG. 4 illustrates an example of steps for identifying a correlation between data from different sonars in order to identify a particular object; and

FIG. 5 shows a schematic block diagram of an information processing device for implementing steps of processing data from sonars, for example the steps illustrated in FIG. 4.

### DETAILED DESCRIPTION

The inventors have determined that by choosing an underwater vehicle such as a towed fish or a drone with variable immersion, navigating close to the seabed, it is not useful to implement a detection sonar in a column of water (that is to say a VSS type sonar) covering 360 degrees in elevation but only part of the hemisphere above the underwater vehicle, for example the 180 degrees of the hemisphere above the underwater vehicle, the hemisphere located under the underwater vehicle being better covered by a seabed imaging sonar, for example a synthetic antenna sonar (or SAS). Indeed, the latter allows the detection of seabed mines and short tethered mines (whose immersion is greater than or equal to that of the underwater vehicle), with much higher performance than known VSS type solutions. In addition, by combining the detection of the float by a sonar covering part of the hemisphere above the underwater vehicle and the toad, or even possibly the rope, by the seabed imaging sonar, an excellent classification and location of long tethered mines (whose immersion is less than that of the underwater vehicle) can be carried out. Furthermore, a choice of a commercially sold sonar for bathymetry or structure inspection then becomes possible for the VSS, considerably reducing the costs of the underwater detection vehicle.

According to particular aspects, it is thus proposed to use a sonar, which is preferably multibeam, oriented towards the surface of the sea (that is to say towards any point on the surface, preferably towards the zenith of the underwater vehicle or nearby) when the underwater vehicle is used for the purposes of detecting and locating an underwater object (that is to say when it is in the detection phase), which emits a broadband code, for example according to a bandwidth comprised between 60 and 80 KHz, with a longitudinal antenna oriented along the axis of movement of the underwater vehicle, thus forming at least one beam which is fine in bearing and wide in elevation (for example of the order of 2 degrees in bearing and 180 degrees in elevation, which can be noted as 2×180). The received signal is preferably received using an antenna oriented transversely, preferably a curved antenna, forming a plurality of beams which are fine in elevation (for example of the order of 2 degrees) thus allowing by intersection of the emission and reception beams the elevation-bearing-range location of any object in a cylindrical volume whose base is defined by the arc of the emission beam and the axis by the rail along which the car moves.

The use of very fine beams in bearing, as well as the high range resolution, makes it possible to detect and locate drifting mines in surface reverberation under excellent conditions (the detection problem is formally identical to that of detection of a seabed mine in the seabed reverberation). According to these aspects, all the measurements carried out in one ping (that is to say in one emission/reception cycle) belong to a volume (or a swath) which can be compared to a plane, for example a swath perpendicular or substantially perpendicular to the movement of the underwater vehicle. The measurements of different planes are carried out at different times, by scanning, by the advancement of the underwater vehicle, and all the measurements of the same plane are carried out in a single ping. It is noted here that an emission/reception cycle corresponds to one or more emissions carried out at a given time and to the reception of the signal(s) emitted at this time.

The underwater vehicle may be an autonomous car, for example an underwater drone, a remotely operated car or a car towed by a surface vessel, which is autonomous or not, such as a towed fish.

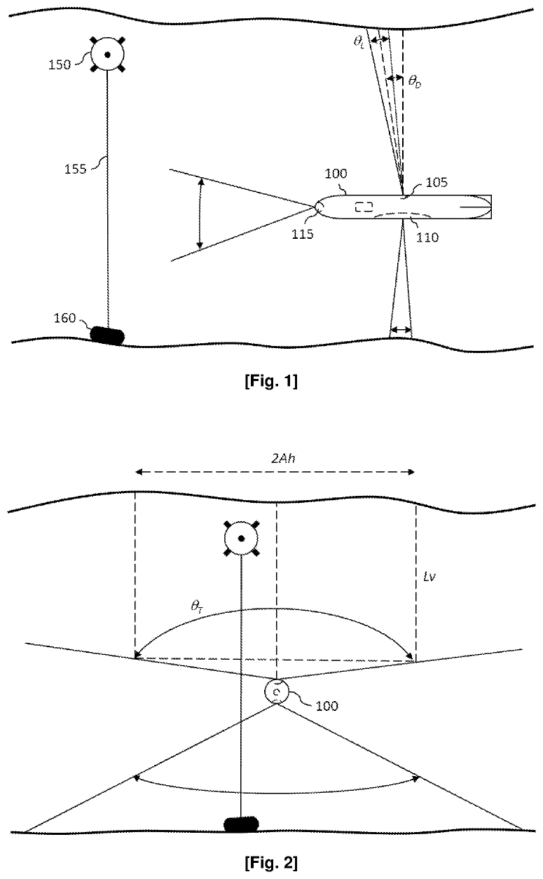

FIG. 1 schematically illustrates an example of an underwater vehicle 100, for example an underwater drone, equipped with sonars, seen from the side. As illustrated, the underwater vehicle 100 here comprises a first sonar 105 such as a scanning sonar, with lateral vision, mounted in the upper part of the vehicle 100, or zenith sonar, allowing the detection and location of objects, in particular tethered mines or drift mines, for example the mine 150, in the part of a water column located between the vehicle 100 and the surface of the water. Examples of features of such sonar are described below. According to the example illustrated in FIG. 1, the vehicle 100 further comprises a second sonar 110 such as a scanning sonar, with lateral vision, mounted in the lower part of the vehicle 100 and allowing detection and localisation of objects, in particular ropes and toads from tethered mines, for example the rope 155 and the toad 160, in the part of a column of water located between the vehicle 100 and the seabed. The sonar 110 is, for example, a synthetic antenna sonar. It can also ensure the detection of seabed mines, and more generally of any object of comparable index placed on the seabed, as well as the detection of tethered mines whose float is at an immersion greater than or equal to that of the underwater vehicle 100. Likewise, still as an example, the vehicle 100 here comprises a frontal avoidance sonar 115.

FIG. 2 schematically illustrates the underwater vehicle 100 shown in FIG. 1, seen from the front.

The upper sonar 105 here comprises a longitudinal emission antenna allowing broadband emission in a swath transverse to the road. The emission sector is advantageously offset, for example by an angle θ_{D} of 5 to 20 degrees forward, to avoid a nadir return. According to aspects, the emission sector is narrow in bearing, forming for example an angle θ_{L} between 1 and 4 degrees, to ensure, in combination with the wide band, good detection performance in the surface reverberation volume, and wide in elevation to provide good volumetric coverage. The angle of emission in elevation, denoted θ_{T}, is preferably comprised between less than 90 degrees and more than 180 degrees, for example an angle comprised between 45 and 240 degrees. This angle defines the sonar intercept, equal to Iₕxlᵥ or 2Aₕxlᵥ (where Iₕ or 2Aₕ is the horizontal intercept and Iᵥ is the vertical intercept), as described with reference to FIG. 2, and therefore, taking into account the speed of the underwater vehicle, the volumetric coverage of the sonar. The upper sonar 105 is for example a multibeam sonar, also known under the name of MBES (multibeam echosounder) type sonar, generally used for bathymetry applications, or a side sonar, also known as SSS (side-scan sonar) type sonar, generally used for imagery applications.

The upper sonar 105 further comprises a transverse receiving antenna. It can be linear or, advantageously, curved to cover a reception angle greater than 180 degrees and maximise the vertical intercept (such that the vertical intercept Iᵥ is greater than or equal to the water height I above the underwater vehicle), forming a plurality of channels in elevation, allowing both better detection and localisation of echoes.

It is observed here that the implementation of side-scan sonar results in there being no coverage in a cylinder around the road. This absence can be covered by the use of a frontal sonar, for example the frontal avoidance sonar 115.

The upper sonar 105 is for example a sonar from the WBMS family from the company Norbit (Norbit is a brand), for example a WBMS STX sonar. These sonars have an aperture in elevation of up to 210 degrees in a single ping, an aperture of 1 degree at a frequency of 400 kHz and 2 degrees at 200 kHz, with a range greater than 150 metres at a frequency of 400 kHz and 350 metres at 200 kHz. They offer a bandwidth greater than 60 KHz with a sound level of 220 dB at a frequency of 400 kHz and 214 dB at 200 kHz. The WBMS STX sonar has programmable emission, allowing shifting of the emission sector and pitch stabilisation.

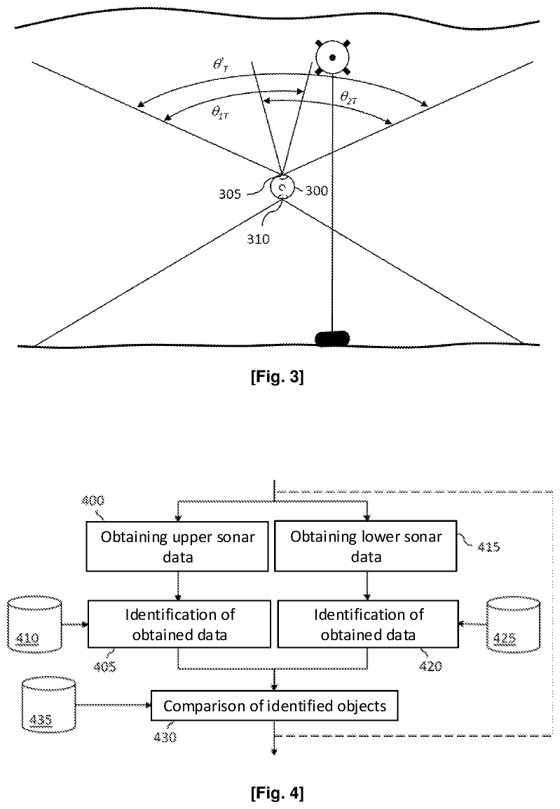

FIG. 3 schematically illustrates a second example of configuration of an underwater vehicle 300, seen from the front, according to aspects of the disclosure. Like the underwater vehicle 100 illustrated in FIGS. 1 and 2, the underwater vehicle 300 here comprises a first sonar 305, mounted in the upper part of the vehicle 300 and allowing the detection of objects, in particular tethered mines or drift mines, in the part of a water column located between the vehicle 300 and the surface of the water. Likewise, the vehicle 300 further comprises a second sonar 310 mounted in the lower part of the vehicle 300 and allowing the detection of objects, in particular toads of tethered mines, in the part of a water column located between the vehicle 300 and the seabed. Again, the sonar 310 is, for example, a synthetic antenna sonar. Likewise, still as an example, the vehicle 300 here comprises a frontal avoidance sonar.

The upper sonar 305 is for example an SSS type sonar made up of two sonars. As illustrated, the emission angle in elevation, denoted θ′_{T}, results from the combination of the emission angle of each of the two sonars, denoted θ_{1T} and θ_{2T}. Again, it is preferably comprised between less than 90 degrees and more than 180 degrees, for example between 45 and 240 degrees. The two sonars constituting the upper sonar 305 can be, for example, side sonars, in particular sonars with a synthetic antenna.

The implementation of an upper sonar and a lower sonar allows to detect seabed mines, tethered mines and drift mines in a single pass with the exception of a blind volume close to the nadir of the underwater vehicle. This blind volume can be filled, in a known manner, by the association of two successive rails, each rail covering the blind volume of the other rail.

According to particular aspects, the upper sonar is electronically scanned in a longitudinal vertical plane of the underwater vehicle, thus allowing to shift the emission beam, for example to compensate for the pitch of the underwater vehicle and ensure optimal volume coverage despite attitude errors. In an extension of this variant, the sonar has coloured emission (the emitted signal comprises several distinct frequencies) in bearing also allowing the compensation of the yaw of the platform and the increase in the number of detection opportunities. The sonar emits, in the same recurrence, several pulses in disjoint sub-bands covering an interval in a longitudinal vertical plane of the underwater vehicle. According to a particular example given for illustration, a bandwidth of 80 KHz is divided into 5 sub-bands of 16 kHz each, which are emitted in the sectors 90 degrees+2 degrees, 90 degrees+1 degrees, 90 degrees, 90 degrees−1 degree, 90 degrees−2 degrees in a vertical longitudinal plane of the underwater vehicle, which allows to cover a sector of 6 degrees without loss of resolution, the latter being fixed at 2 degrees. The multiple echoes of a target can then be subject to tracking and incoherent integration, using the navigation of the underwater vehicle or even micro-navigation in the case where the underwater vehicle is equipped with a synthetic antenna sonar. Incoherent integration allows to reduce the natural fluctuations of the echoes of both the targets and the environment (of surface reverberation in particular), and therefore to flatten the probability distribution tails of the corresponding amplitudes and thus to increase the detection probability and to reduce false alarms.

According to particular aspects, the underwater vehicle comprises a processing unit which receives data from the upper and lower sonars to identify a correlation between these data in relation to predetermined models, for example to establish a correlation between data likely to have a tethered mine with data likely to have a rope or a toad, allowing excellent classification of the tethered mine.

FIG. 4 illustrates steps of such aspects. As illustrated, a first step here aims at obtaining data from the upper sonar (step 400). In a following step (step 405), the data obtained are processed, for example to reduce noise, and compared to data representative of searched objects, for example data representative of tethered mines, stored in a database 410, to determine if the data obtained are likely to characterise a searched object. A confidence level can be associated with each potentially identified object. The position of potentially identified objects is preferably determined.

Similarly, data from the lower sonar is obtained (step 415). In a following step (step 420), the data obtained from the lower sonar are processed, for example to reduce noise, and compared to data representative of sought objects, for example data representative of a rope, a toad or a seabed mine, stored in a database 425 to determine if the data obtained are likely to characterise a searched object. The position of potentially identified objects is preferably determined.

In a following step (step 430), a correlation is carried out between the objects potentially identified from the data obtained from the upper sonar and the objects potentially identified from the data obtained from the lower sonar from references stored in a database 435. Thus, for example, if data obtained from the upper sonar are potentially identified as representative of a tethered mine and if data obtained from the lower sonar are potentially identified as representative of a toad, the level of confidence associated with the identification of each of these objects can be incremented. Conversely, if, for example, data obtained from the upper sonar are potentially identified as representative of a tethered mine and if data obtained from the lower sonar are potentially identified as representative of a seabed mine, there is no need to modify the level of confidence associated with the identification of each of these objects. The relative position of potentially identified objects, for example the relative position of a tethered mine and a toad, is also preferably used to modify the level of confidence associated with the identification of each of these objects.

It is observed here that the databases 410, 425 and 435 may be separate databases or may constitute one or more databases.

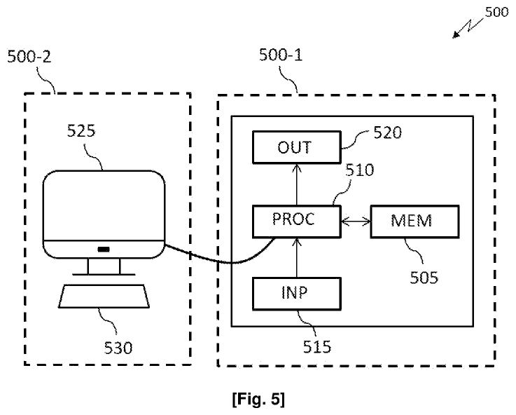

FIG. 5 shows a schematic block diagram of an information processing device 500 for implementing steps described previously, in particular steps described with reference to FIG. 4. According to the example illustrated, the information processing device 500 comprises two parts, a first part 500-1 which can be implemented in an underwater vehicle according to the disclosure and a second part 500-2 belonging here to a remote system, for example a surface ship. Processed or unprocessed data, for example data from sonars, can be exchanged between the parts 500-1 and 500-2 using a wired connection or wireless communication means.

As illustrated, the device 500 may comprise a memory 505 for storing instructions allowing the implementation of the method, the received data from the backscattered signal, and temporary data for carrying out the different steps of a method as described above.

The device may further include a circuit 510. This circuit may, for example, be:
a processor capable of interpreting instructions in the form of a computer program, or
an electronic card whose steps of the method of the disclosure are described in silicon, or else
a programmable electronic chip, such as an FPGA (for “Field-Programmable Gate Array”), a SOC (for “System On Chip”), a GPU (for “Graphics Processing Unit”), or an ASIC (for “Application Specific Integrated Circuit”) chip.

SOCs or system on a chip are embedded systems that integrate all the components of an electronic system into a single chip. An ASIC is a specialised electronic circuit that brings together custom functionalities for a given application. ASICs are generally configured during manufacture and can only be simulated by the user. Programmable logic circuits of the FPGA (Field-Programmable Gate Array) type are user-reconfigurable electronic circuits.

The device 500 may include an input interface 515, for example for receiving data from one or more sonars and an output interface 520, for example for transmitting these processed or unprocessed data, and/or identifiers of potentially identified objects.

Moreover, the device can include, to allow easy interaction with a user and to display detection results, a screen 525 and a keyboard 530. Of course, the keyboard is optional, in particular in the context of a computer in the form of a touchscreen tablet, for example. As illustrated, the screen and/or keyboard are preferably remote.

Depending on the aspect, the part 500-1 of the device 500 may be a calculator, an electronic component, or another apparatus including a processor operationally coupled to a memory, as well as, depending on the chosen aspect, a data storage unit, and other associated hardware elements such as a network interface and a media drive for reading from and writing to a removable storage medium (not shown in the figure). The removable storage medium may be, for example, a memory card.

Depending on the aspect, the memory, the data storage unit or the removable storage medium contains instructions which, when executed by the control circuit 510, cause this control circuit 510 to perform or control the input interface 515, output interface 520, data storage in memory 505 and/or data processing parts according to one or more aspects of the proposed method.

It is observed here that if all the steps can be implemented in a device of the underwater vehicle, some steps can be implemented in the underwater vehicle while other steps are implemented in a remote device. Thus, for example, the correlation between objects potentially identified from data obtained from the upper sonar and objects potentially identified from data obtained from the lower sonar can be carried out in a device of a surface ship receiving identification of the objects potentially detected.

Of course, the present disclosure is not limited to the aspects described above by way of examples. It extends to other variants.

Depending on the chosen aspect, certain acts, actions, events or functions of each of the methods described in this document may be carried out or occur in an order different from that wherein they were described, or may be added, merged or not be carried out or not occur, as the case may be. Furthermore, in some aspects, certain acts, actions or events are performed or occur concurrently and not successively.

Although described through a certain number of detailed exemplary aspects, the device and the method proposed comprise different variants, modifications and improvements which will be obvious to the person skilled in the art, it being understood that these different variants, modifications and improvements are part of the scope of the disclosure, as defined by the claims which follow. In addition, different aspects and features described above may be implemented together, or separately, or in substitution for each other, and all the different combinations and sub-combinations of the aspects and features are within the scope of the disclosure. Furthermore, some systems and equipment described above may not incorporate all the modules and functions described for the preferred aspects.

What is claimed is:

1. An underwater vehicle provided with at least a first sonar and a second sonar, for the detection of underwater objects, the at least one first sonar being a sonar whose angular coverage in elevation is comprised between 45 and 240 degrees, is oriented towards the surface when the underwater vehicle is in the detection phase of an underwater object and whose angular coverage in bearing is less than 10 degrees to obtain measurements in a plane, all the measurements of a plane being obtained in one emission/reception cycle, the at least one first sonar allowing the detection of underwater objects located at a depth less than that of the underwater vehicle, the second sonar being configured to detect underwater objects located at a depth greater than that of the underwater vehicle, the underwater vehicle further comprising correlation means for correlating data from said at least first sonar and said second sonar, an underwater object being identified and located according to a correlation result.

2. The vehicle according to claim 1, according to which the at least one first sonar is provided with a longitudinal emission antenna oriented along the axis of the underwater vehicle, allowing broadband emission.

3. The vehicle according to claim 1, according to which the at least one first sonar is provided with a linear or curved transverse reception antenna.

4. The vehicle according to claim 1, according to which the cover is oriented forward in a longitudinal vertical plane of the underwater vehicle, at an angle comprised between 5 and 25 degrees when the underwater vehicle is in the detection phase of an underwater object.

5. The vehicle according to claim 4, according to which the at least one first sonar is with a scanning in a longitudinal vertical plane of the underwater vehicle, said scanning in a longitudinal vertical plane of the underwater vehicle being controlled independently of the advance of the underwater vehicle.

6. The vehicle according to claim 1, according to which the at least one first sonar is a multibeam sonar.

7. The vehicle according to claim 1, according to which the at least one first sonar is a side sonar.

8. The vehicle according to claim 7, according to which the at least one first sonar is a synthetic antenna sonar.

9. The vehicle according to claim 7 according to which the at least one first sonar has coloured emission.

10. The vehicle according to claim 1, according to which the at least one first sonar is made up of a plurality of sonars.

11. The vehicle according to claims 1 according to which the second sonar is a synthetic antenna sonar.

12. The vehicle according to claim 1, according to which the vehicle is autonomous.

13. A method for detecting an underwater object, in an underwater vehicle provided with at least a first sonar and a second sonar, the method comprising
the emission, by the at least one first sonar, of an acoustic signal towards the surface according to an angular coverage in elevation comprised between 45 and 240 degrees and an angular coverage in bearing less than 10 degrees,
the acquisition of acoustic signals in return of the signal emitted towards the surface, to obtain measurements in a plane, all the measurements of a plane being obtained in one emission/reception cycle,
the emission, by the second sonar, of an acoustic signal towards the seabed,
the acquisition of acoustic signals in return of the signal emitted towards the seabed and
the processing of the acquired signals to detect and locate an underwater object located at a depth less than that of the underwater vehicle, said processing comprising a correlation of data obtained by processing the acquired signals in return for the signals emitted towards the surface and towards the seabed.

14. The method according to claim 13, according to which the acoustic signal emitted towards the surface is emitted forward in a longitudinal vertical plane of the underwater vehicle, at an angle comprised between 5 and 25 degrees.
